(19) United States
(12) Patent Application Publication
(10) Pub. No.: US 2009/0186271 A1
(43) Pub. Date: Jul. 23, 2009

(54) NON-AQUEOUS ELECTROLYTE BATTERY AND ELECTRODE, AND METHOD FOR MANUFACTURING THE SAME

(75) Inventors: Shinya Wakita, Fukushima (JP); Izaya Okae, Fukushima (JP); Masanori Soma, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/358,779

(22) Filed: Mar. 30, 2009

(30) Foreign Application Priority Data
Jan. 23, 2008 (JP) P2008-012696

(51) Int. Cl. H01M 4/60; B05D 5/12

(52) U.S. Cl. 429/213; 427/58

(57) ABSTRACT

A non-aqueous electrolyte battery including a positive electrode; a negative electrode; and a non-aqueous electrolyte, wherein at least one of the positive electrode and the negative electrode has an active material layer containing an ambient temperature molten salt and polyvinylpyrrolidone.

### CROSS REFERENCES TO RELATED APPLICATIONS

The present application claims priority to Japanese Patent Application JP 2008-012696 filed in the Japan Patent Office on Jan. 23, 2008, the entire contents of which is being incorporated herein by reference.

### BACKGROUND

The present application relates to an electrode containing an ambient temperature molten salt and a method for forming the same and to a battery using such an electrode.

In recent years, downsizing and weight saving of portable electronic devices represented by a mobile phone, PDA (personal digital assistant) and a laptop personal computer have been actively promoted. As a part thereof, an enhancement in energy density of a battery as a driving power source for such electronic devices, in particular, a secondary battery has been eagerly desired.

As a secondary battery capable of obtaining a high energy density, there are known, for example, secondary batteries using lithium (Li) as an electrode reactant. Above all, a lithium ion secondary battery using a carbon material capable of intercalating lithium in a negative electrode and deintercalating it therefrom is widely put into practical use. However, in the lithium ion secondary battery using a carbon material for a negative electrode, technologies have already been developed to an extent close to a theoretical capacity thereof. Thus, as a method for further enhancing the energy density, there has been studied a method in which the thickness of an active material layer is increased, thereby increasing a proportion of the active material layer within the battery and decreasing a proportion of each of a collector and a separator (see, for example, JP-A-9-204936).

### SUMMARY

However, when the thickness of the active material layer is increased without changing a volume of the battery, the area of the collector relatively decreases. Thus, a current density to be applied to the electrode increases, resulting in an enormous lowering of cycle characteristics. Consequently, it has been difficult to increase the thickness of the active material layer.

Also, when the thickness of the active material layer is increased, or the volumetric density is increased, impregnation properties of an electrolytic solution become worse, and maintenance of the electrolytic solution within an electrode is lowered. Therefore, the current non-uniformly flows within the electrode, whereby cycle characteristics are easily deteriorated. Consequently, it has been difficult to increase the thickness of the active material layer or to increase the volumetric density.

In view of the foregoing problems, it is desirable to provide a battery capable of obtaining a high energy density and also obtaining excellent cycle characteristics.

According to an embodiment, there are provided the following non-aqueous electrolyte battery and electrode and method for manufacturing the same.

[1] A non-aqueous electrolyte battery including a positive electrode, a negative electrode and a non-aqueous electrolyte, wherein

at least one of the positive electrode and the negative electrode has an active material layer containing an ambient temperature molten salt and polyvinylpyrrolidone.

[2] A method for manufacturing a non-aqueous electrolyte battery including a positive electrode, a negative electrode and a non-aqueous electrolyte, which includes the steps of:

coating an electrode mixture coating solution containing an active material, an ambient temperature molten salt, polyvinylpyrrolidone and a solvent on a collector and then volatilizing the solvent to form at least one of a positive electrode active material layer and a negative electrode active material layer.

[3] An electrode including a collector and an active material layer, wherein

the active material layer contains an ambient temperature molten salt and polyvinylpyrrolidone.

[4] A method for manufacturing an electrode including a collector and an active material layer, which includes the steps of:

coating an electrode mixture coating solution containing an active material, an ambient temperature molten salt, polyvinylpyrrolidone and a solvent on a collector and then volatilizing the solvent to form the active material layer.

In the non-aqueous battery and the electrode according to the embodiment, when the active material layer contains an appropriate amount of the ambient temperature molten salt as well as the active material, even in the case of imparting ionic conductivity to a binder to increase the thickness of the electrode or increase the volumetric density of the electrode, the cycle characteristics are not lowered. Also, since polyvinylpyrrolidone is contained, the ambient temperature molten salt with high viscosity is favorably dispersed, and the ionic conductivity within the electrode is kept extremely favorable.

Consequently, in the battery according to an embodiment, since the ambient temperature molten salt and polyvinylpyrrolidone are contained in the electrode, not only the energy density can be enhanced, but excellent cycle characteristics can be obtained.

Additional features and advantages are described herein, and will be apparent from the following Detailed Description and the figures.

### BRIEF DESCRIPTION OF THE FIGURES

FIG. 1 is a cross-sectional view showing a configuration of a secondary battery according to an embodiment.

FIG. 2 is a cross-sectional view showing an enlarged part of a wound electrode body in the secondary battery as shown in FIG. 1.

### DETAILED DESCRIPTION

Embodiments of the present application are described in detail below with reference to the accompanying drawings.

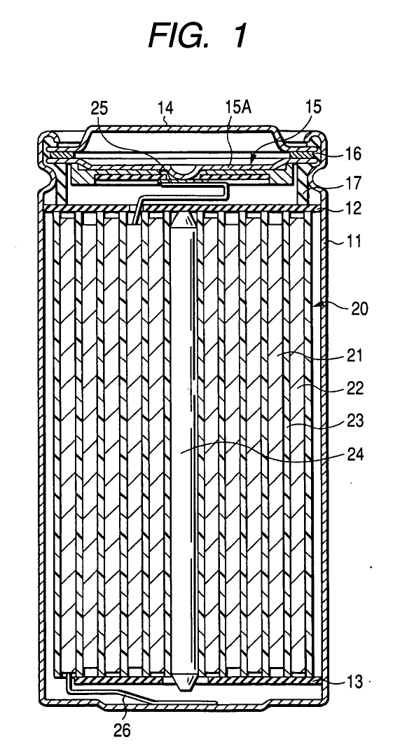

FIG. 1 shows a cross-sectional structure of a secondary battery according to an embodiment. This secondary battery is of a so-called cylinder type and has a wound electrode body 20 in which strip-shaped positive electrode 21 and negative electrode 22 are wound via a separator 23 in the interior of a battery can 11 in a substantially hollow column shape. The battery can 11 is constituted of, for example, iron (Fe) plated with nickel (Ni). One end of the battery can 11 is closed, with the other end being opened. A pair of insulating plates 12 and 13 is respectively disposed perpendicular to the winding peripheral face in the interior of the battery can 11 so as to interpose the wound electrode body 20 therebetween.

In the open end of the battery can 11, a battery cover 14 and a safety valve mechanism 15 and a positive temperature coefficient (PTC) device 16 provided inside this battery cover 14 are installed upon being caulked via a gasket 17, and the interior of the battery can 11 is hermetically sealed. The battery cover 14 is constituted of, for example, a material the same as in the battery can 11. The safety valve mechanism 15 is electrically connected to the battery cover 14 via the positive temperature coefficient device 16. When an internal pressure of the battery reaches a certain level or more due to an internal short circuit, heating from the exterior or the like, a disk plate 15A is reversed, thereby cutting electrical connection between the battery cover 14 and the wound electrode body 20. When the temperature rises, the positive temperature coefficient device 16 limits a current due to an increase of a resistance value, thereby preventing abnormal heat generation due to a large current from occurring. The gasket 17 is constituted of, for example, an insulating material, and its surface is coated with asphalt.

For example, a center pin 24 is inserted in the center of the wound electrode body 20. A positive electrode lead 25 made of aluminum (Al) or the like is connected to the positive electrode 21 of the wound electrode body 20; and a negative electrode lead 26 made of nickel or the like is connected to the negative electrode 22 of the wound electrode body 20. The positive electrode lead 25 is electrically connected to the battery cover 14 upon being welded with the safety valve mechanism 15; and the negative electrode lead 26 is welded with and electrically connected to the battery can 11.

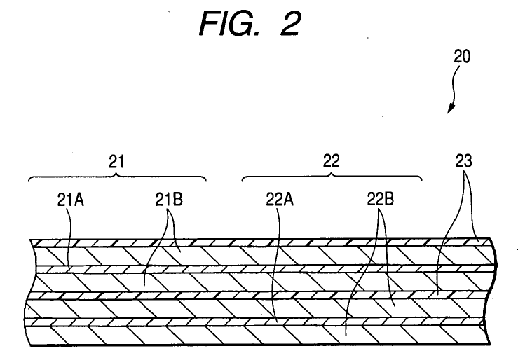

FIG. 2 shows an enlarged part of the wound electrode body 20 as shown in FIG. 1. The positive electrode 21 has a structure in which, for example, a positive electrode active material layer 21B is provided on the both faces of a positive electrode collector 21A having a pair of faces opposing to each other. Though illustration is omitted, the positive electrode active material layer 21B may be provided on only one face of the positive electrode collector 21A. The positive electrode collector 21A is constituted of, for example, a metal foil such as an aluminum foil, a nickel foil and a stainless steel foil.

(Positive Electrode)

The positive electrode 21 has, for example, a configuration in which the positive electrode active material layer 21B is provided on the both faces of the positive electrode collector 21A having a pair of faces opposing to each other. Though illustration is omitted, the positive electrode active material layer 21B may be provided on only one face of the positive electrode collector 21A. The positive electrode collector 21A is constituted of, for example, a metal foil such as a copper foil, a nickel foil and a stainless steel foil.

The positive electrode active material layer 21B is, for example, constituted so as to contain, as the positive electrode active material, a positive electrode active material capable of intercalating and deintercalating lithium as an electrode reactant. From the viewpoint of a high capacity, it is preferable that the positive electrode active material layer 21B has a thickness on one face of from 75 to 120 μm and a volumetric density of from 3.50 to 3.70 g/cm³.

As the positive electrode material capable of intercalating and deintercalating lithium, lithium-containing compounds such as a lithium oxide, a lithium sulfide, an intercalation compound containing lithium and a lithium phosphate compound are suitable, and mixtures of plural kinds thereof may also be used. Of these, a complex oxide containing lithium and a transition metal element or a phosphate compound containing lithium and a transition metal element is preferable; and a compound containing at least one of cobalt (Co), nickel, manganese (Mn), iron, aluminum, vanadium (V) and titanium (Ti) as a transition metal element is especially preferable. A chemical formula thereof is expressed by, for example, LiₓM1O₂ or Li_{y}M2PO₄. In the formula, M1 and M2 each includes a single kind or plural kinds of a transition metal element; and values of x and y vary depending upon the charge and discharge state of the battery and are usually satisfied with the relationships of (0.05≦x≦1.10) and (0.05≦y≦1.10).

Specific examples of the complex oxide containing lithium and a transition metal element include a lithium cobalt complex oxide (LiₓCoO₂), a lithium nickel complex oxide and a lithium manganese complex oxide having a spinel structure (LiMn₂O₄). Specific examples of the lithium nickel complex oxide include LiNiₓCo₁₋ₓO₂ (0≦x≦1), LiₓNiO₂, LiNiₓCo_{y}O₂ and LiₓNi₁₋ₓCO_{z}O₂ (z<1). Specific examples of the phosphate compound containing lithium and a transition metal element include a lithium iron phosphate compound (LiFePO₄) and a lithium iron manganese phosphate compound [LiFe₁₋ᵤMnᵤPO₄ (u<1)].

Also, as the positive electrode material capable of intercalating and deintercalating lithium, other metal compound and a polymer material can also be exemplified. Examples of other metal compound include oxides such as titanium oxide, vanadium oxide and manganese dioxide; and disulfides such as titanium sulfide and molybdenum sulfide. Examples of the polymer material include polyaniline and polythiophene.

(Negative Electrode)

The negative electrode 22 has, for example, a configuration in which a negative electrode active material layer 22B is provided on the both faces of a negative electrode collector 22A having a pair of faces opposing to each other. Though illustration is omitted, the negative electrode active material layer 22B may be provided on only one face of the negative electrode collector 22A. The negative electrode collector 22A is constituted of, for example, a metal foil such as a copper foil, a nickel foil and a stainless steel foil.

The negative electrode active material layer 22B is, for example, constituted so as to contain, as the negative electrode active material, a single kind or plural kinds of a negative electrode material capable of intercalating and deintercalating lithium as an electrode reactant. The negative electrode active material layer 22B may also contain, for example, a conductive material and a binder the same as in the positive electrode active material layer 21B as the need arises. From the viewpoint of a high capacity, it is preferable that the negative electrode active material layer 22B has a thickness on one face of from 65 to 110 μm and a volumetric density of from 1.70 to 1.85 g/cm³.

Examples of the negative electrode material capable of intercalating and deintercalating lithium include carbon materials such as graphite, hardly graphitized carbon and easily graphitized carbon. Such a carbon material is preferable because a change in the crystal structure to be generated at the time of charge and discharge is very little, a high charge and discharge capacity can be obtained, and favorable charge and discharge cycle characteristics can be obtained. In particular, graphite is preferable because it is able to obtain a large electrochemical equivalent and a high energy density.

As the graphite, one having a true density of 2.10 g/cm³ or more is preferable, and one having a true density of 2.18 g/cm³ or more is more preferable. In order to obtain such a true density, it is necessary that the thickness of a crystallite in the C-axis on the (002) plane is 14.0 nm or more. Also, a lattice spacing of the (002) plane of the graphite is preferably less than 0.340 nm, and more preferably in the range of 0.335 nm or more and not more than 0.337 nm. The graphite may be any of natural graphite and artificial graphite.

As the hardly graphitized carbon, for example, one which has a lattice spacing of the (002) plane of 0.37 nm or more and a true density of less than 1.70 g/cm³ and which does not show an exothermic peak at 700° C. or higher in differential thermal analysis (DTA) in air is preferable.

As the negative electrode material capable of intercalating and deintercalating lithium, a negative electrode material which is capable of intercalating and deintercalating lithium and which contains, as a constitutional element, at least one of a metal element and a semi-metal element is also exemplified. This is because by using such a negative electrode material, a high energy density can be obtained. This negative electrode material may be a single body, an alloy or a compound of a metal element or a semi-metal element. Also, one having a single kind or plural kinds of a phase in at least a part thereof may be used. In an embodiment according to the present application, the alloy also includes an alloy containing a single kind or plural kinds of a metal element and a single kind or plural kinds of a semi-metal element in addition to alloys composed of plural kinds of a metal element. In addition, the aloy may also include non-metal element. Examples of its texture include a solid solution, a eutectic (eutectic mixture), an intermetallic compound and one in which plural kinds thereof coexist.

Examples of the metal element or semi-metal element constituting the negative electrode material include magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt), each of which is capable of forming an alloy together with lithium. These may be crystalline or amorphous.

Above all, as the negative electrode material, ones containing, as a constitutional element, a metal element or a semi-metal element belonging to the Group 4B in the short form of the periodic table are preferable, and ones containing, as a constitutional element, at least one of silicon and tin are especially preferable. This is because silicon and tin have large ability for intercalating and deintercalating lithium and are able to obtain a high energy density.

Examples of alloys of tin include alloys containing, as a second constitutional element other than tin, at least one member selected from the group consisting of silicon, nickel, copper (Cu), iron, cobalt, manganese, zinc, indium, silver, titanium (Ti), germanium, bismuth, antimony (Sb) and chromium (Cr). Examples of alloys of silicon include alloys containing, as a second constitutional element other than silicon, at least one member selected from the group consisting of tin, nickel, copper, iron, cobalt, manganese, zinc, indium, silver, titanium, germanium, bismuth, antimony and chromium.

Examples of compounds of tin or compounds of silicon include compounds containing oxygen (O) or carbon (C), and these compounds may contain the foregoing second constitutional element in addition to tin or silicon.

(Additives in Active Material Layer)

At least one of the positive electrode active material layer 21B and the negative electrode active material layer 22B further contains an ambient temperature molten salt and polyvinylpyrrolidone. The content of the ambient temperature molten salt in each of the positive electrode active material layer 21B and the negative electrode active material layer 22B is preferably in the range of from 0.1 to 3 parts by mass, and more preferably in the range of from 0.2 to 1 part by mass based on 100 parts by mass of the total sum of the active material, the conductive agent and the binder. This is because when the content of the ambient temperature molten salt falls within the foregoing range, favorable cycle characteristics are obtainable. When the content of the ambient temperature molten salt in the active material layer is a concentration exceeding 3 parts by mass, not only peel strength, press characteristics and loading characteristics are lowered, but cycle characteristics are lowered.

Also, the content of polyvinylpyrrolidone in each of the positive electrode active material layer 21B and the negative electrode active material layer 22B is preferably in the range of from 0.01 to 1 part by mass based on 100 parts by mass of the total sum of the active material, the conductive agent and the binder. When the content of polyvinylpyrrolidone falls within the foregoing range, the ambient temperature molten salt can be favorably dispersed, and hence, such is preferable. When the addition concentration is too high, not only loading characteristics are lowered, but cycle characteristics are lowered.

It is preferable that the ambient temperature molten salt contains a tertiary or quaternary ammonium salt composed of, for example, a tertiary or quaternary ammonium cation and a fluorine atom-containing anion. This is because by using the tertiary or quaternary ammonium salt, reductive decomposition of the electrolytic solution as described later can be inhibited. The ambient temperature molten salt may be used singly or in admixture of plural kinds thereof. The tertiary or quaternary ammonium cation also includes one having characteristics of a tertiary or quaternary ammonium cation.

Examples of the quaternary ammonium cation include a cation having a structure represented by the following formula (1).

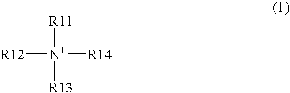

In the formula (1), R11 to R14 each independently represents an aliphatic group, an aromatic group, a heterocyclic group or a group in which a part of the element or elements of any one of these groups is substituted with a substituent. R11 to R14 may be the same or different.

Examples of the aliphatic group include an alkyl group and an alkoxyl group. Examples of the alkyl group include a methyl group, an ethyl group, a propyl group, a hexyl group and an octyl group. Examples of the group in which a part of the element or elements of the aliphatic group is substituted with a substituent include a methoxyethyl group. Examples of the substituent include a hydrocarbon group having from 1 to 10 carbon atoms, a hydroxyalkyl group having from 1 to 10 carbon atoms and an alkoxyalkyl group.

Examples of the aromatic group include an aryl group.

Examples of the heterocyclic group include pyrrole, pyridine, imidazole, pyrazole, benzimidazole, piperidine, pyrrolidine, carbazole, quinoline, pyrrolidinium, piperidinium and piperazinium.

Examples of the cation having a structure represented by the formula (1) include an alkyl quaternary ammonium cation and a cation in which a part of the functional group or groups of the foregoing cation is substituted with a hydrocarbon group having from 1 to 10 carbon atoms, a hydroxyalkyl group having from 1 to 10 carbon atoms or an alkoxyalkyl group having from 1 to 10 carbon atoms. As the alkyl quaternary ammonium cation, (CH₃)₃R5N⁺(R5 represents an alkyl group or an alkenyl group each having from 3 to 8 carbon atoms) is preferable. Examples of such a cation include a trimethylpropylammonium cation, a trimethyloctylammonium cation, a trimethylallylammonium cation, a trimethylhexylammonium cation and an N,N-diethyl-N-methyl-N-(2-methoxyethyl)ammonium cation.

Also, as the tertiary or quaternary ammonium cation other than the cation having a structure represented by the formula (1), a nitrogen-containing heterocyclic cation having a structure represented by any one of the following formulae (2) to (5) is exemplified. The nitrogen-containing heterocyclic cation as referred to herein refers to one having a positive charge on the nitrogen atom constituting a heterocyclic ring as represented by any one of the formulae (2) to (5).

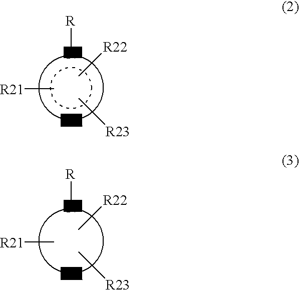

The formula (2) represents a structure having a conjugated bond; and the formula (3) represents a structure not having a conjugated bond. In the formulae (2) and (3), m is from 4 to 5; R21 to R23 each independently represents a hydrogen atom, an alkyl group having from 1 to 5 carbon atoms, an alkoxy group, an amino group or a nitro group and may be the same or different; R represents a hydrogen atom or an alkyl group having from 1 to 5 carbon atoms; and the nitrogen atom is a tertiary or quaternary ammonium cation.

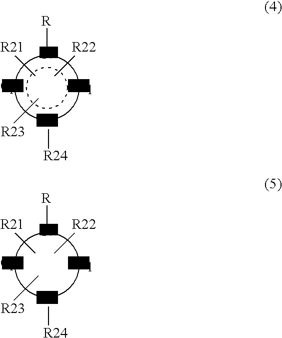

The formula (4) represents a structure having a conjugated bond; and the formula (5) represents a structure not having a conjugated bond. In the formulae (4) and (5), p is from 0 to 2; (p+q) is from 3 to 4; R21 to R23 each independently represents a hydrogen atom, an alkyl group having from 1 to 5 carbon atoms, an alkoxy group having from 1 to 5 carbon atoms, an amino group or a nitro group and may be the same or different; R24 represents an alkyl group having from 1 to 5 carbon atoms; R represents a hydrogen atom or an alkyl group having from 1 to 5 carbon atoms; and the nitrogen atom is a tertiary or quaternary ammonium cation.

Examples of the nitrogen-containing heterocyclic cation having a structure represented by any one of the formula (2) to (5) include a pyrrolium cation, a pyridinium cation, an imidazolium cation, a pyrazolium cation, a benzimidazolium cation, an indolium cation, a carbazolium cation, a quinolinium cation, a pyrrolidinium cation, a piperidinium cation, a piperazinium cation and a cation in which a part of the functional group or groups of any one of these cations is substituted with a hydrocarbon group having from 1 to 10 carbon atoms, a hydroxyalkyl group or an alkoxyalkyl group having from 1 to 10 carbon atoms. Examples of such a nitrogen-containing heterocyclic cation include an ethylmethylimidazolium cation and an N-methyl-N-propylpiperidinium cation.

Examples of the fluorine atom-containing anion include BF₄⁻, PF₆⁻, CₙF₂ₙ₊₁CO₂⁻ (n represents an integer of from 1 to 4), CₘF₂ₘ₊₁SO₃⁻(m represents an integer of from 1 to 4), (FSO₂)₂N⁻, (CF₃SO₂)₂N⁻, (C₂F₅SO₂)₂N⁻, (CF₃SO₂)(C₄F₉SO₂)N⁻, (CF₃SO₂)₃C⁻, CF₃SO₂—N⁻—COCF₃ and R5-SO₂—N⁻—SO₂CF₃ (R5 represents an aliphatic group or an aromatic group). Of these, BF₄⁻, (F—SO₂)₂—N⁻, (CF₃—SO₂)₂—N⁻, (C₂F₅SO₂)₂N⁻ and (CF₃SO₂)(C₄F₉SO₂)N⁻ are preferable; and BF₄⁻, (F—SO₂)₂—N⁻ and (CF₃—SO₂)₂—N⁻ are more preferable.

As the ambient temperature molten salt composed of a cation having a structure represented by the formula (1) and a fluorine atom-containing anion, one composed of an alkyl quaternary ammonium cation and a fluorine atom-containing anion is especially preferable. Above all, an ambient temperature molten salt using, as the alkyl quaternary ammonium cation, (CH₃)₃R5N⁺ (R5 represents an alkyl group or an alkenyl group each having from 3 to 8 carbon atoms) and, as the fluorine atom-containing anion, (CF₃SO₂)₂N⁻, (C₂F₅SO₂)₂N⁻ or (CF₃SO₂)(C₄F₉SO₂)N⁻ is more preferable. Examples of such an ambient temperature molten salt include trimethylpropylammonium•bis(trifluoromethylsulfonyl)imide, trimethyloctylammonium•bis(trifluoromethylsulfonyl)imide, trimethylallylammonium•bis(trifluoromethylsulfonyl)imide and trimethylhexylammonium•bis(trimethylfluorosulfonyl)imide.

In addition to the foregoing, there are exemplified N,N-diethyl-N-methyl-N-(2-methoxyethyl)ammonium•bis(trifluoromethylsulfonyl)imide (hereinafter referred to as “DEME•TFSI”) and N,N-diethyl-N-methyl-N-(2-methoxyethyl)ammonium•tetrafluoroborate (hereinafter referred to as “DEME•BF₄”).

Examples of the ambient temperature molten salt composed of a nitrogen-containing heterocyclic cation and a fluorine atom-containing anion include 1-ethyl-3-methylimidazolium•bis(trifluoromethylsulfonyl)imide (hereinafter referred to as “EMI•TFSI”), 1-ethyl-3-methylimidazolium•tetrafluoroborate (hereinafter referred to as “EMI•BF₄”), N-methyl-N-propylpiperidinium•bis(trifluoromethylsulfonyl)imide (hereinafter referred to as “PP13•TFSI”) and N-methyl-N-propylpiperidinium•bis(fluorosulfonyl)imide (hereinafter referred to as “PP13•FSI”).

Each of the positive electrode active material layer 21B and the negative electrode active material layer 22B may contain a conductive agent and a binder as the need arises. Examples of the conductive agent include carbon materials such as graphite, carbon black and ketjen black. These materials are used singly or in admixture of plural kinds thereof. Also, besides the carbon material, a metal material, a conductive polymer material or the like may be used so far as the material is a conductive material.

As the binder, for example, a vinylidene fluoride-containing polymer is preferable. This is because such a polymer has high stability in the battery. Such a binder may be used singly or in admixture of plural kinds thereof. Examples of the vinylidene fluoride-containing polymer as a major component include vinylidene fluoride based polymers or copolymers. Examples of the vinylidene fluoride based polymer include polyvinylidene fluoride (PVdF). Also, examples of the vinylidene fluoride based copolymer include a vinylidene fluoride-hexafluoropropylene copolymer, a vinylidene fluoride-tetrafluoroethylene copolymer, a vinylidene fluoride-carboxylic acid copolymer and a vinylene fluoride-hexafluoropropylene-carboxylic acid copolymer.

(Separator)

The separator 23 isolates the positive electrode 21 and the negative electrode 22 from each other, prevents a short circuit of current to be caused due to contact of the both electrodes from occurring and passes a lithium ion therethrough. The separator 23 is constituted of, for example, a porous membrane made of a synthetic resin such as polytetrafluoroethylene, polypropylene and polyethylene or a porous membrane made of an inorganic material such as a ceramic-made non-woven fabric. The separator 23 may also have a porous membrane structure in which two or more kinds of the foregoing porous membranes are laminated. Above all, a polyolefin-made porous membrane is preferable because it is excellent in an effect for preventing a short circuit from occurring and is able to devise to enhance safety of the battery due to a shutdown effect. In particular, polyethylene is preferable as a material which constitutes the separator 23 because it is able to obtain a shutdown effect within a temperature range of 100° C. or higher and not higher than 160° C. and is excellent in electrochemical stability. Also, polypropylene is preferable. Besides, a resin may be used upon being copolymerized or blended with polyethylene or polypropylene so far as it has chemical stability.

(Non-Aqueous Electrolyte)

A liquid non-aqueous electrolytic solution is impregnated as a non-aqueous electrolyte in the separator 23. The non-aqueous electrolytic solution contains, for example, a solvent and an electrolyte salt dissolved in the solvent.

Examples of the solvent include carbonate based non-aqueous solvents such as ethylene carbonate, diethyl carbonate, ethyl methyl carbonate, propylene carbonate, dimethyl carbonate, vinylene carbonate and fluoroethyl carbonate. Examples of other solvent include 4-fluoro-1,3-dioxolan-2-one, γ-butyrolactone, γ-valerolactone, 1,2-dimethoxyethane, tetrahydrofuran, 2-methyltetrahydrofuran, 1,3-dioxolan, 4-methyl-1,3-dioxolan, methyl acetate, methyl propionate, ethyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, nitromethane, nitroethane, sulfolane, dimethyl sulfoxide, trimethyl phosphate, triethyl phosphate and ethylene sulfite. Above all, ethylene carbonate, propylene carbonate, vinylene carbonate, dimethyl carbonate, ethyl methyl carbonate and ethylene sulfite are preferable because excellent charge and discharge capacity characteristics and charge and discharge cycle characteristics can be obtained.

Examples of the electrolyte salt include lithium electrolyte salts such as lithium hexafluorophosphate (LiPF₆), lithium bis(pentafluoroethanesulfonyl)imide [Li(C₂F₅SO₂)₂N], lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide [Li(CF₃ SO₂)₂N], tris(trifluoromethanesulfonyl)methyl lithium [LiC(SO₂CF₃)₃], lithium chloride (LiCl) and lithium bromide (LiBr). These electrolyte salts are used singly or in admixture of plural kinds thereof.

Also, in the foregoing embodiment, the case of using a liquid electrolytic solution as an electrolyte has been described. However, an electrolyte in a gel form in which an electrolytic solution is held in a holding body such as a polymer compound may be used. Examples of such a polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene and polycarbonate. In particular, polyacrylonitrile, polyvinylidene fluoride, polyhexafluoropropylene and polyethylene oxide are preferable in view of electrochemical stability. A proportion of the polymer compound to the electrolytic solution varies with compatibility therebetween. In general, it is preferable to add the polymer compound in an amount corresponding to 5% by mass or more and not more than 50% by mass of the electrolytic solution.

(Manufacturing Method)

The foregoing secondary battery can be, for example, manufactured in the following manner.

First of all, a positive electrode active material, a conductive agent and a binder are mixed to prepare a positive electrode mixture. This positive electrode mixture is dispersed in a solvent such as N-methyl-2-pyrrolidone to form a pasty positive electrode mixture coating solution (slurry). In the case of containing an ambient temperature molten salt and polyvinylpyrrolidone in the positive electrode active material layer, these are contained in the positive electrode mixture. Subsequently, the positive electrode mixture coating solution is coated on the positive electrode collector 21A, and the solvent is then volatilized. Furthermore, the resultant is compression molded by a rolling press machine or the like to form the positive electrode active material layer 21B. There is thus prepared the positive electrode 21.

Also, a negative electrode active material and a binder and optionally, an ambient temperature molten salt and polyvinylpyrrolidone are mixed to prepare a negative electrode mixture. This negative electrode mixture is dispersed in a solvent such as N-methyl-2-pyrrolidone to form a pasty negative electrode mixture coating solution (slurry). In the case of containing the ambient temperature molten salt and polyvinylpyrrolidone in the negative electrode active material layer, these are contained in the negative electrode mixture. Subsequently, the negative electrode mixture coating solution is coated on the negative electrode collector 22A, and the solvent is then volatilized. Furthermore, the resultant is compression molded by a rolling press machine or the like to form the negative electrode active material layer 22B. There is thus prepared the negative electrode 22.

Next, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded with the safety valve mechanism 15; and a tip end of the negative electrode lead 26 is welded with the battery can 11. The wound positive electrode 21 and negative electrode 22 are interposed between a pair of the insulating plates 12 and 13 and contained in the interior of the battery can 11. After the positive electrode 21 and the negative electrode 22 are contained in the interior of the battery can 11, an electrolytic solution is injected into the interior of the battery can 11 and impregnated in the separator 23. Thereafter, the battery cover 14, the safety valve mechanism 15 and the positive temperature coefficient device 16 are fixed to the open end of the battery can 11 upon being caulked via the gasket 17. There is thus completed the secondary battery as shown in FIG. 1.

In the foregoing secondary battery, when charged, for example, a lithium ion is deintercalated from the positive electrode active material layer 21B and intercalated in the negative electrode active material layer 22B via the electrolytic solution. Also, when discharged, for example, a lithium ion is deintercalated from the negative electrode active material layer 22B and intercalated in the positive electrode active material layer 21B via the electrolytic solution.

While the present application has been described with reference to the foregoing embodiment, it should not be construed that the present application is limited thereto, and various modifications may be made. For example, in the foregoing embodiment, the battery using lithium as an electrode reactant has been described. However, the present application can be applied to the case of using other alkali metal such as sodium (Na) and potassium (K), an alkaline earth metal such as magnesium and calcium (Ca), or other light metal such as aluminum. On that occasion, the positive electrode active material capable of intercalating and deintercalating an electrode reactant and the like are selected depending upon the electrode reactant.

Also, in the foregoing embodiment, the secondary battery of a cylinder type having a winding structure has been specifically described. However, the present application is similarly applicable to a secondary battery of an oval type or a polygonal type having a winding structure, or a secondary battery having other structure in which a positive electrode and a negative electrode are folded, or plural positive electrodes and negative electrodes are laminated. In addition, the present application is similarly applicable to secondary batteries having other shape such as a coin type, a button type, a square type and a laminated film type.

Moreover, in the foregoing embodiment, with respect to the content of the ambient temperature molten salt which is contained in the positive electrode active material layer or negative electrode active material layer in the battery, an appropriate range to be lead out from the results of the following Examples has been described. However, the subject description does not completely deny a possibility that the content of the ambient temperature molten salt falls outside the foregoing range. That is, the foregoing appropriate range is an especially preferred range to the last in view of obtaining the effect according to an embodiment. So far as the effect according to the embodiment is obtainable, the content of the ambient temperature molten salt may slightly fall outside the foregoing range. Also, for example, even in the case where following the use after the manufacture or the like, the ambient temperature molten salt contained in the electrode diffuses into the electrolytic solution, thereby causing a change of the concentration of the ambient temperature molten salt in the electrode, the effect according to the embodiment is obtainable so far as a prescribed amount of the ambient temperature molten salt exists over the whole of the battery.

### EXAMPLES

Embodiments are specifically described below in detail with reference to the following Examples.

### Examples 1-1 to 1-7 and Comparative Examples 1-1 to 1-3

The secondary battery of a cylinder type as shown in FIGS. 1 and 2 was prepared. First of all, lithium carbonate (Li₂CO₃) and cobalt carbonate (CoCO₃) were mixed in a molar ratio of Li₂CO₃/CoCO₃ of 0.5/1, and the mixture was baked in air at 900° C. for 5 hours to obtain a lithium cobalt complex oxide (LiCoO₂). The obtained LiCoO₂ was subjected to X-ray diffraction. The result was well consistent with a peak of LiCoO₂ registered in the JCPDS (Joint Committee of Powder Diffraction Standard) file. Next, this lithium cobalt complex oxide was pulverized to form a positive electrode active material in a powder form having an accumulated 50% particle size obtained by laser diffraction of 15 μm.

Subsequently, 95% by mass of this lithium cobalt complex oxide powder and 5% by mass of a lithium carbonate (Li₂CO₃) powder were mixed; 94% by mass of this mixture, 3% by mass of ketjen black as a conductive agent and 3% by mass of polyvinylidene fluoride as a binder were mixed. To this mixture, DEME•TFSI which is an ambient temperature molten salt of a quaternary ammonium salt and polyvinylpyrrolidone were further simply added, and the resulting mixture was dispersed in N-methyl-2-pyrrolidone as a solvent to prepare a positive electrode mixture coating solution. The content of each of the ambient temperature molten salt and polyvinylpyrrolidone in the positive electrode active material layer 21B was varied relative to 100 parts by mass of the total sum of the positive electrode active material, the conductive agent and the binder as shown in Table 1 as described later. Next, this positive electrode mixture coating solution was uniformly coated on the both faces of the positive electrode collector 21A made of a strip-shaped aluminum foil having a thickness of 15 μm and then thoroughly dried at 130° C. The resultant was compression molded to form the positive electrode active material layer 21B, thereby preparing the positive electrode 21.

The N-methyl-2-pyrrolidone which is the solvent has a vapor pressure such that it evaporates at 130° C. On the other hand, the vapor pressure of DEME•TFSI which is the ambient temperature molten salt is closer and closer to zero. For that reason, the N-methyl-2-pyrrolidone completely vaporizes and evaporates, and then, it becomes disappeared. Therefore, the DEME•TFSI remains as a liquid in the positive electrode active material layer 21B. A thickness of one face of the positive electrode active material layer 21B was 100 μm, and a volume density thereof was 3.52 g/cm³. After preparing the positive electrode 21, the positive electrode lead 25 made of aluminum was installed in one end of the positive electrode collector 21A.

Also, 90% by mass of a granular graphite powder having an average particle size of 25 μm as a negative electrode active material and 10% by mass of polyvinylidene fluoride (PVdF) as a binder were mixed, and the mixture was dispersed in N-methyl-2-pyrrolidone as a solvent to form a negative electrode mixture coating solution. Thereafter, this negative electrode mixture coating solution was uniformly coated on the both faces of the negative electrode collector 22A made of a strip-shaped copper foil having a thickness of 10 μm and then dried. The resultant was compression molded to form the negative electrode active material layer 22B, thereby preparing the negative electrode 22. On that occasion, a thickness of one face of the negative electrode active material layer 22B was 90 μm, and a volume density thereof was 1.75 g/cm³. After preparing the negative electrode 22, the negative electrode lead 26 made of nickel was installed in one end of the negative electrode collector 22A.

After preparing the positive electrode 21 and the negative electrode 22, respectively, the positive electrode 21 and the negative electrode 22 were laminated via the separator 23 made of a microporous polyethylene film having a thickness of 22 μm. The resulting laminate was wound around a core having a diameter of 3.2 mm, thereby preparing the wound electrode body 20. Next, the wound electrode body 20 was interposed between a pair of the insulating plates 12 and 13; not only the negative electrode lead 26 was welded with the battery can 11, but the positive electrode lead 25 was welded with the safety valve mechanism 15; and the wound electrode body 20 was then contained in the interior of the nickel-plated iron-made battery can 11. Subsequently, an electrolytic solution was injected into the interior of the battery can 11, and the battery cover 14 was caulked with the battery can 11 via the gasket 17, thereby preparing a secondary battery of a cylinder type.

On that occasion, a solution prepared by dissolving, as an electrolyte salt, lithium hexafluorophosphate in a proportion of 1.0 mole/kg in a mixed solvent of vinylene carbonate (VC), ethylene carbonate (EC), fluoroethylene carbonate (FEC), diethyl carbonate (DEC) and propylene carbonate (PC) in a proportion of 1/30/10/49/10 was used as the electrolytic solution.

Each of the secondary batteries prepared in Examples 1-1 to 1-7 and Comparative Examples 1-1 to 1-3 was subjected to charge and discharge and examined with respect to a maintenance ratio of discharge capacity. On that occasion, charge was performed at a constant current of 0.7 C until a battery voltage reached 4.2 V and then performed at a constant voltage of 4.2 V until a total charge time reached 4 hours; and discharge was performed at a constant current of 0.5 C until a battery voltage reached 3.0 V. “1 C” as referred to herein represents a current value at which a theoretical capacity is completely discharged within one hour. A ratio of the discharge capacity at the 100th cycle to the discharge capacity at the first cycle, namely [{(discharge capacity at the 100th cycle)/(discharge capacity at the first cycle)}×100(%)] was defined for the maintenance ratio of discharge capacity. The results are shown in Table 1. The content of each of the ambient temperature molten salt and polyvinylpyrrolidone in the positive electrode active material layer is expressed in terms of a part by mass based on 100 parts by mass of the total mass of the active material, the conductive agent and the binder.

TABLE 1
Addition in positive electrode

| | Ambient temperature molten salt | | Polyvinylpyrrolidone | Cycle characteristics |
|---|---|---|---|---|
| | Kind | (Part by mass) | (Part by mass) | (%) |
| Example 1-1 | DEME•TFSI | 0.05 | 0.5 | 66 |
| Example 1-2 | DEME•TFSI | 0.1 | 0.5 | 81 |
| Example 1-3 | DEME•TFSI | 0.5 | 0.5 | 84 |
| Example 1-4 | DEME•TFSI | 1.0 | 0.5 | 89 |
| Example 1-5 | DEME•TFSI | 2.0 | 0.5 | 81 |
| Example 1-6 | DEME•TFSI | 3.0 | 0.5 | 80 |
| Example 1-7 | DEME•TFSI | 3.5 | 0.5 | 68 |
| Comparative | DEME•TFSI | 0.0 | 0.5 | 64 |
| Example 1-1 | | | | |
| Comparative | DEME•TFSI | 1.0 | 0.0 | 65 |
| Example 1-2 | | | | |
| Comparative | DEME•TFSI | 0.0 | 0.0 | 59 |
| Example 1-3 | | | | |

As shown in Table 1, in Examples 1-1 to 1-7 in which the ambient temperature molten salt and polyvinylpyrrolidone were contained in the positive electrode, favorable cycle characteristics were obtained as compared with Comparative Examples 1-1 and 1-2 in which only either one of them was contained. Also, favorable cycle characteristics were obtained as compared with Comparative Example 1-3 in which the both were not contained. It is considered that this was caused, by incorporating the ambient temperature molten salt in the positive electrode, the mobility of a lithium ion in polyvinylidene fluoride as the binder was enhanced. Furthermore, it is considered that this was caused, by incorporating polyvinylpyrrolidone in the positive electrode, the mobility of a lithium ion in polyvinylidene fluoride as the binder in the electrode, which is able to well dissolve the ambient temperature molten salt with high viscosity therein, was enhanced.

Also, in Example 1-2 in which the amount of the ambient temperature molten salt in the positive electrode active material layer was regulated at 0.1 parts by mass, the cycle characteristics were enormously enhanced. On the other hand, from the results of Examples 1-6 and 1-7, when the amount of the ambient temperature molten salt exceeded 3.0 parts by mass, the cycle characteristics was liable to be lowered. It is considered that this was caused due to peel characteristics of the electrode were lowered, whereby the maintenance of the mixture within the electrode became worse. It was noted from this matter that the content of the ambient temperature molten salt in the positive electrode active material layer is preferably from 0.1 to 3.0 parts by mass based on 100 parts by mass of the total sum of the active material, the conductive agent and the binder.

### Examples 2-1 to 2-7

Secondary batteries having the same configuration as in Example 1-4, except for the point that the addition amount of polyvinylpyrrolidone was different, were prepared. Each of these secondary batteries of Examples 2-1 to 2-7 was subjected to charge and discharge and examined with respect to the maintenance ratio of discharge capacity in the same manners as in Example 1-4. The results are shown in Table 2.

TABLE 2
Addition in positive electrode

| | Ambient temperature molten salt | | Polyvinylpyrrolidone | Cycle characteristics |
|---|---|---|---|---|
| | Kind | (Part by mass) | (Part by mass) | (%) |
| Example 2-1 | DEME•TFSI | 1.0 | 0.005 | 67 |
| Example 2-2 | DEME•TFSI | 1.0 | 0.01 | 80 |
| Example 2-3 | DEME•TFSI | 1.0 | 0.05 | 84 |
| Example 2-4 | DEME•TFSI | 1.0 | 0.1 | 92 |
| Example 1-4 | DEME•TFSI | 1.0 | 0.5 | 89 |
| Example 2-5 | DEME•TFSI | 1.0 | 0.8 | 81 |
| Example 2-6 | DEME•TFSI | 1.0 | 1.0 | 77 |
| Example 2-7 | DEME•TFSI | 1.0 | 1.5 | 62 |
| Comparative | DEME•TFSI | 0.0 | 0.5 | 64 |
| Example 1-1 | | | | |
| Comparative | DEME•TFSI | 1.0 | 0.0 | 65 |
| Example 1-2 | | | | |
| Comparative | DEME•TFSI | 0.0 | 0.0 | 59 |
| Example 1-3 | | | | |

As shown in Table 2, in Example 2-2 in which the content of polyvinylpyrrolidone in the positive electrode active material layer was 0.01 parts by mass, the cycle characteristics were enormously enhanced. On the other hand, it was noted from the results of Examples 2-6 and 2-7 that when the amount of polyvinylpyrrolidone exceeded 1.0 part by mass, the cycle characteristics was liable to be lowered. It is considered that this was caused due to the matter that polyvinylpyrrolidone was excessively decomposed on the surface of the active material, whereby loading characteristics of the battery were lowered. It was noted from this matter that the content of polyvinylpyrrolidone in the positive electrode active material layer is preferably from 0.01 to 1.0 part by mass based on 100 parts by mass of the total sum of the active material, the conductive agent and the binder.

### Examples 3-1 to 3-4

As Examples 3-1 to 3-4, secondary batteries having the same configuration as in Example 1-4, except for the point that the kind of the ambient temperature molten salt to be contained in the positive electrode active material layer 21B was different, were prepared. The results are shown in Table 3.

TABLE 3
Addition in positive electrode

| | Ambient temperature molten salt | | Polyvinylpyrrolidone | Cycle characteristics |
|---|---|---|---|---|
| | Kind | (Part by mass) | (Part by mass) | (%) |
| Example 3-1 | MEI•TFSI | 1.0 | 0.5 | 86 |
| Example 3-2 | PP13•TFSI | 1.0 | 0.5 | 88 |
| Example 3-3 | EMI•BF₄ | 1.0 | 0.5 | 85 |
| Example 3-4 | DEME•BF₄ | 1.0 | 0.5 | 88 |
| Example 1-4 | DEME•TFSI | 1.0 | 0.5 | 89 |

As shown in Table 3, in all of Examples 3-1 to 3-4, extremely excellent cycle characteristics were obtained. It was noted from this matter that various ambient temperature molten salts contribute to the enhancement of cycle characteristics.

### Examples 4-1 to 4-7 and Comparative Examples 2-1 to 2-3

As Examples 4-1 to 4-7 and Comparative Examples 2-1 to 2-3, secondary batteries were prepared in the same manner as in Examples 1-1 to 1-7 and Comparative Examples 1-1 to 1-3, except that the ambient temperature molten salt and polyvinylpyrrolidone were contained in the negative electrode active material layer 22B in place of the positive electrode active material layer 21B. However, the content of the ambient temperature molten salt in the negative electrode active material layer 22B was varied relative to 100 parts by mass of the total sum of the negative electrode active material, the conductive agent and the binder as shown in Table 4 as described later. Each of these secondary batteries was subjected to charge and discharge and examined with respect to the maintenance ratio of charge capacity in the same manners as in Examples 1-1 to 1-7 and Comparative Examples 1-1 to 1-3. The results are shown in Table 4. The content of each of the ambient temperature molten salt and polyvinylpyrrolidone in the negative electrode active material layer is expressed in terms of a part by mass based on 100 parts by mass of the total sum of the active material, the conductive agent and the binder.

TABLE 4
Addition in negative electrode

| | Ambient temperature molten salt | | Polyvinylpyrrolidone | Cycle characteristics |
|---|---|---|---|---|
| | Kind | (Part by mass) | (Part by mass) | (%) |
| Example 4-1 | DEME•TFSI | 0.05 | 0.5 | 67 |
| Example 4-2 | DEME•TFSI | 0.1 | 0.5 | 80 |
| Example 4-3 | DEME•TFSI | 0.5 | 0.5 | 85 |
| Example 4-4 | DEME•TFSI | 1.0 | 0.5 | 91 |
| Example 4-5 | DEME•TFSI | 2.0 | 0.5 | 83 |
| Example 4-6 | DEME•TFSI | 3.0 | 0.5 | 81 |
| Example 4-7 | DEME•TFSI | 3.5 | 0.5 | 69 |
| Comparative | DEME•TFSI | 0.0 | 0.5 | 62 |
| Example 2-1 | | | | |
| Comparative | DEME•TFSI | 1.0 | 0.0 | 63 |
| Example 2-2 | | | | |
| Comparative | DEME•TFSI | 0.0 | 0.0 | 54 |
| Example 2-3 | | | | |

As shown in Table 4, in Examples 4-1 to 4-7 in which the ambient temperature molten salt and polyvinylpyrrolidone were contained in the negative electrode, favorable cycle characteristics were obtained as compared with Comparative Examples 2-1 and 2-2 in which only either one of them was contained. Also, favorable cycle characteristics were obtained as compared with Comparative Example 2-3 in which the both were not contained. It is considered that this was caused, by incorporating the ambient temperature molten salt in the negative electrode, the mobility of a lithium ion in polyvinylidene fluoride as the binder was enhanced. Furthermore, it is considered that this was caused, by incorporating polyvinylpyrrolidone in the negative electrode, the mobility of a lithium ion in polyvinylidene fluoride as the binder in the electrode, which is able to well dissolve the ambient temperature molten salt with high viscosity therein, was enhanced.

Also, in Example 4-2 in which the amount of the ambient temperature molten salt in the negative electrode active material layer was regulated at 0.1 parts by mass, the cycle characteristics were enormously enhanced. On the other hand, from the results of Examples 4-6 and 4-7, when the amount of the ambient temperature molten salt exceeded 3.0 parts by mass, the cycle characteristics was liable to be lowered. It is considered that this was caused due to peel characteristics of the electrode were lowered, whereby the maintenance of the mixture within the electrode became worse. It was noted from this matter that the content of the ambient temperature molten salt in the negative electrode active material layer is preferably from 0.1 to 3.0 parts by mass based on 100 parts by mass of the total sum of the active material, the conductive agent and the binder.

### Examples 5-1 to 5-7

Secondary batteries having the same configuration as in Example 4-4, except for the point that the addition amount of polyvinylpyrrolidone was different, were prepared. Each of these secondary batteries of Examples 5-1 to 5-7 was subjected to charge and discharge and examined with respect to the maintenance ratio of discharge capacity in the same manners as in Example 4-4. The results are shown in Table 5.

TABLE 5
Addition in negative electrode

| | Ambient temperature molten salt | | Polyvinylpyrrolidone | Cycle characteristics |
|---|---|---|---|---|
| | Kind | (Part by mass) | (Part by mass) | (%) |
| Example 5-1 | DEME•TFSI | 1.0 | 0.005 | 68 |
| Example 5-2 | DEME•TFSI | 1.0 | 0.01 | 79 |
| Example 5-3 | DEME•TFSI | 1.0 | 0.05 | 87 |
| Example 5-4 | DEME•TFSI | 1.0 | 0.1 | 93 |
| Example 4-4 | DEME•TFSI | 1.0 | 0.5 | 91 |
| Example 5-5 | DEME•TFSI | 1.0 | 0.8 | 82 |
| Example 5-6 | DEME•TFSI | 1.0 | 1.0 | 76 |
| Example 5-7 | DEME•TFSI | 1.0 | 1.5 | 61 |
| Comparative | DEME•TFSI | 0.0 | 0.5 | 62 |
| Example 2-1 | | | | |
| Comparative | DEME•TFSI | 1.0 | 0.0 | 63 |
| Example 2-2 | | | | |
| Comparative | DEME•TFSI | 0.0 | 0.0 | 54 |
| Example 2-3 | | | | |

As shown in Table 5, in Example 5-2 in which the content of polyvinylpyrrolidone in the negative electrode active material layer was 0.01 parts by mass, the cycle characteristics were enormously enhanced. On the other hand, it was noted from the results of Examples 5-6 and 5-7 that when the amount of polyvinylpyrrolidone exceeded 1.0 part by mass, the cycle characteristics was liable to be lowered. It is considered that this was caused due to the matter that polyvinylpyrrolidone was excessively decomposed on the surface of the active material, whereby loading characteristics of the battery were lowered. It was noted from this matter that the content of polyvinylpyrrolidone in the negative electrode active material layer is preferably from 0.01 to 1.0 part by mass based on 100 parts by mass of the total sum of the active material, the conductive agent and the binder.

### Examples 6-1 to 6-4

As Examples 6-1 to 6-4, secondary batteries having the same configuration as in Example 4-4, except for the point that the kind of the ambient temperature molten salt to be contained in the negative electrode active material layer 22B was different, were prepared. The results are shown in Table 6.

TABLE 6
Addition in negative electrode

| | Ambient temperature molten salt | | Polyvinylpyrrolidone | Cycle characteristics |
|---|---|---|---|---|
| | Kind | (Part by mass) | (Part by mass) | (%) |
| Example 6-1 | MEI•TFSI | 1.0 | 0.5 | 84 |
| Example 6-2 | PP13•TFSI | 1.0 | 0.5 | 87 |
| Example 6-3 | EMI•BF₄ | 1.0 | 0.5 | 82 |
| Example 6-4 | DEME•BF₄ | 1.0 | 0.5 | 83 |
| Example 4-4 | DEME•TFSI | 1.0 | 0.5 | 91 |

As shown in Table 6, in all of Examples 6-1 to 6-4, extremely excellent cycle characteristics were obtained. It was noted from this matter that various ambient temperature molten salts contribute to the enhancement of cycle characteristics.

While the present application has been described with reference to the foregoing embodiments and Examples, it should not be construed that the present application is limited to the foregoing embodiment and Examples, and various modifications may be made.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A non-aqueous electrolyte battery comprising:
a positive electrode;
a negative electrode; and
a non-aqueous electrolyte, wherein
at least one of the positive electrode and the negative electrode has an active material layer containing an ambient temperature molten salt and polyvinylpyrrolidone.

2. The non-aqueous electrolyte battery according to claim 1, wherein
the active material layer contains an active material, a conductive agent and a binder; and
the content of the ambient temperature molten salt is from 0.1 to 3 parts by mass based on 100 parts by mass of the total sum of the active material, the conductive agent and the binder.

3. The non-aqueous electrolyte battery according to claim 1, wherein the ambient temperature molten salt contains a tertiary or quaternary ammonium salt composed of a tertiary or quaternary ammonium cation and a fluorine atom-containing anion.

4. The non-aqueous electrolyte battery according to claim 3, wherein the tertiary or quaternary ammonium cation is a cation having a structure represented by any one of the following formulae (1) to (5): 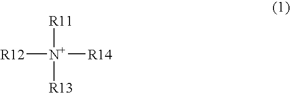
wherein R11 to R14 each independently represents an aliphatic group, an aromatic group, a heterocyclic group or a group in which a part of the element or elements of any one of these groups is substituted with a substituent, 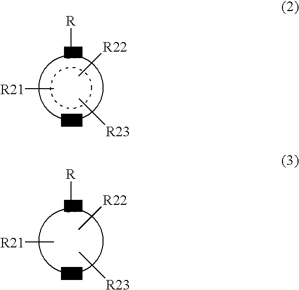
wherein m is from 4 to 5; R21 to R23 each independently represents a hydrogen atom, an alkyl group having from 1 to 5 carbon atoms, an alkoxy group, an amino group or a nitro group and may be the same or different; R represents a hydrogen atom or an alkyl group having from 1 to 5 carbon atoms; and the nitrogen atom is a tertiary or quaternary ammonium cation, and 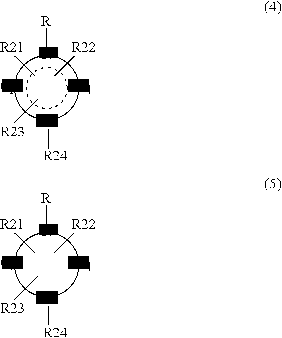
wherein p is from 0 to 2; (p+q) is from 3 to 4; R21 to R23 each independently represents a hydrogen atom, an alkyl group having from 1 to 5 carbon atoms, an alkoxy group having from 1 to 5 carbon atoms, an amino group or a nitro group and may be the same or different; R24 represents an alkyl group having from 1 to 5 carbon atoms; R represents a hydrogen atom or an alkyl group having from 1 to 5 carbon atoms; and the nitrogen atom is a tertiary or quaternary ammonium cation.

5. The non-aqueous electrolyte battery according to claim 4, wherein the cation having a structure represented by any one of the formulae (1) to (5) is an alkyl quaternary ammonium cation, an N-methyl-N-propylpiperidinium cation or an N,N-diethyl-N-methyl-N-(2-methoxyethyl)ammonium cation.

6. The non-aqueous electrolyte battery according to claim 3, wherein the fluorine atom-containing anion is BF₄⁻, (F—SO₂)₂—N⁻ or (CF₃—SO₂)₂—N⁻.

7. The non-aqueous electrolyte battery according to claim 1, wherein
the active material layer contains an active material, a conductive agent and a binder; and
the content of the polyvinylpyrrolidone is from 0.01 to 1 part by mass based on 100 parts by mass of the total sum of the active material, the conductive agent and the binder.

8. The non-aqueous electrolyte battery according to claim 1, wherein the active material layer contains a vinylidene fluoride-containing polymer.

9. A method for manufacturing a non-aqueous electrolyte battery including a positive electrode, a negative electrode and a non-aqueous electrolyte, comprising:
coating an electrode mixture coating solution containing an active material, an ambient temperature molten salt, polyvinylpyrrolidone and a solvent on a collector and then volatilizing the solvent to form at least one of a positive electrode active material layer and a negative electrode active material layer.

10. An electrode comprising:
a collector and
an active material layer, wherein
the active material layer contains an ambient temperature molten salt and polyvinylpyrrolidone.

11. The electrode according to claim 10, wherein
the active material layer contains an active material, a conductive agent and a binder; and
the content of the ambient temperature molten salt is from 0.1 to 3 parts by mass based on 100 parts by mass of the total sum of the active material, the conductive agent and the binder.

12. The electrode according to claim 10, wherein the ambient temperature molten salt contains a tertiary or quaternary ammonium salt composed of a tertiary or quaternary ammonium cation and a fluorine atom-containing anion.

13. The electrode according to claim 12, wherein the tertiary or quaternary ammonium cation is a cation having a structure represented by any one of the following formulae (1) to (5): 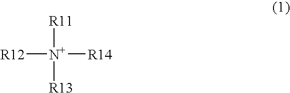
wherein R11 to R14 each independently represents an aliphatic group, an aromatic group, a heterocyclic group or a group in which a part of the element or elements of any one of these groups is substituted with a substituent, 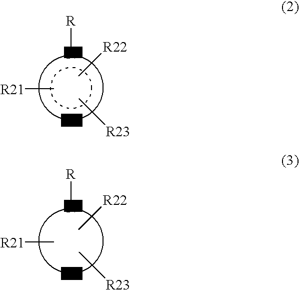
wherein m is from 4 to 5; R21 to R23 each independently represents a hydrogen atom, an alkyl group having from 1 to 5 carbon atoms, an alkoxy group, an amino group or a nitro group and may be the same or different; R represents a hydrogen atom or an alkyl group having from 1 to 5 carbon atoms; and the nitrogen atom is a tertiary or quaternary ammonium cation, and 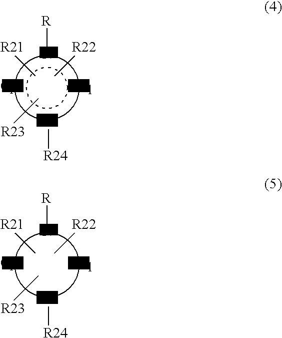
wherein p is from 0 to 2; (p+q) is from 3 to 4; R21 to R23 each independently represents a hydrogen atom, an alkyl group having from 1 to 5 carbon atoms, an alkoxy group having from 1 to 5 carbon atoms, an amino group or a nitro group and may be the same or different; R24 represents an alkyl group having from 1 to 5 carbon atoms; R represents a hydrogen atom or an alkyl group having from 1 to 5 carbon atoms; and the nitrogen atom is a tertiary or quaternary ammonium cation.

14. The electrode according to claim 13, wherein the cation having a structure represented by any one of the formulae (1) to (5) is an alkyl quaternary ammonium cation, an N-methyl-N-propylpiperidinium cation or an N,N-diethyl-N-methyl-N-(2-methoxyethyl)ammonium cation.

15. The electrodey according to claim 12, wherein the fluorine atom-containing anion is BF₄—, (F—SO₂)₂—N⁻ or (CF₃—SO₂)₂—N⁻.

16. The electrode according to claim 10, wherein
the active material layer contains an active material, a conductive agent and a binder; and
the content of the polyvinylpyrrolidone is from 0.01 to 1 part by mass based on 100 parts by mass of the total sum of the active material, the conductive agent and the binder.

17. The electrode according to claim 10, wherein the active material layer contains a vinylidene fluoride-containing polymer.

18. A method for manufacturing an electrode including a collector and an active material layer, comprising:
coating an electrode mixture coating solution containing an active material, an ambient temperature molten salt, polyvinylpyrrolidone and a solvent on a collector and then volatilizing the solvent to form the active material layer.
